(19) United States
(12) Patent Application Publication
(10) Pub. No.: US 2017/0037946 A1
(43) Pub. Date: Feb. 9, 2017

(54) TRANSMISSION FOR A POWERTRAIN

(71) Applicant: GM GLOBAL TECHNOLOGY OPERATIONS LLC, Detroit, MI (US)

(72) Inventors: Chi-Kuan Kao, Troy, MI (US); Chunhao J. Lee, Troy, MI (US)

(73) Assignee: GM GLOBAL TECHNOLOGY OPERATIONS LLC, Detroit, MI (US)

(21) Appl. No.: 14/820,746

(22) Filed: Aug. 7, 2015

(51) Int. Cl. F16H 37/02

(52) U.S. Cl. CPC F16H 37/022

(57) ABSTRACT

A transmission includes a continuously variable unit and a fixed-gear-ratio unit. The continuously variable unit includes a variator input, and a variator output that is continuously connected to the transmission output member. A first torque transmitting mechanism interconnects the variator input and a transmission input member. The fixed-gear-ratio unit includes a single planetary gear set having a ring gear, planet gears supported by a carrier, and a sun gear. The fixed-gear-ratio unit includes a fixed input and a fixed output. The fixed input is continuously connected to the transmission input member, and one node of the planetary gear set. The fixed output is continuously connected to the transmission output member, and is selectively connected to another node of the planetary gear set. The fixed-gear-ratio unit includes second, third, fourth, and fifth torque transmitting mechanisms that are selectively engageable and/or disengageable for changing between fixed gear ratios.

### TECHNICAL FIELD

The disclosure generally relates to a transmission for a powertrain of a vehicle.

### BACKGROUND

Vehicle powertrains include an internal combustion engine that is coupled to a transmission. The engine provides a rotational output. The transmission converts the rotational speed and torque of the output from the engine, and transmits the torque to a final drive of the vehicle. The transmission may include a fixed-gear-ratio transmission, or a continuously or infinitely variable transmission (CVT). A fixed-gear-ratio transmission is operable to change between a pre-defined number of fixed gear ratios. A fixed-gear-ratio transmission may use one or more torque transmitting mechanisms, e.g., clutches and/or brakes, to connect and/or disconnect different components of a gear set to define the different gear ratios. The number of available gear ratios of a fixed-gear-ratio transmission is limited. Typically, a fixed-fear ratio transmission may include between 3 and 6 different gear ratios. A continuously variable transmission is operable to steplessly change through an infinite number of effective gear ratios between a maximum gear ratio and a minimum gear ratio. Examples of continuously variable transmissions include, but are not limited to, a belt-style continuously variable transmission including two adjustable diameter pulleys, or a toroidal style continuously variable transmission using a pair of opposing roller mechanisms that transmit torque and rotation between a pair of opposing discs.

### SUMMARY

A transmission for a powertrain is provided. The transmission includes a transmission input member, and a transmission output member. A continuously variable unit includes a variator input that is selectively coupled to the transmission input member, and a variator output that is continuously connected to the transmission output member. A fixed-gear-ratio unit includes a planetary gear set having a ring gear, a plurality of planet gears supported by a carrier, and a sun gear. The ring gear, the planet gears, and the sun gear are disposed in meshing engagement with each other. Each of the ring gear, the carrier, and the sun gear define one of a first node, a second node, or a third node of the planetary gear set. The fixed-gear-ratio unit includes a fixed input and a fixed output. The fixed input is continuously connected to the transmission input member and one of the first node, the second node, or the third node of the planetary gear set. The fixed output is continuously connected to the transmission output member, and is selectively connected to one of the first node, the second node, or the third node of the planetary gear set.

A powertrain for a vehicle is also provided. The powertrain includes an engine, and a transmission. The transmission is coupled to the engine, and is operable to receive torque from the engine. The transmission includes a transmission input member and a transmission output member. The transmission input member is connected to the engine, and is operable to receive the torque from the engine. A continuously variable unit includes a variator input, and a variator output that is continuously connected to the transmission output member. A first torque transmitting mechanism interconnects the variator input and the transmission input member. The first torque transmitting mechanism is operable to selectively connect or disconnect the variator input and the transmission input member in torque communication therebetween. A fixed-gear-ratio unit includes a planetary gear set having a ring gear, a plurality of planet gears supported by a carrier, and a sun gear. The ring gear, the planet gears, and the sun gear are disposed in meshing engagement with each other. The fixed-gear-ratio unit includes a fixed input and a fixed output. The fixed input is continuously connected to the transmission input member, and one of the ring gear, the carrier, or the sun gear. The fixed output is continuously connected to the transmission output member, and is selectively connected to a respective one of the ring gear, the carrier, or the sun gear. A second torque transmitting mechanism interconnects a respective one of the ring gear, the carrier, or the sun gear, and the fixed output of the fixed-gear-ratio unit. The second torque transmitting mechanism is operable to selectively connect or disconnect the respective one of the ring gear, the carrier, or the sun gear with the fixed output of the fixed-gear-ratio unit in torque communication therebetween. A third torque transmitting mechanism interconnects a respective one of the ring gear, the carrier, or the sun gear, and the fixed output of the fixed-gear-ratio unit. The third torque transmitting mechanism is operable to selectively connect or disconnect the respective one of the ring gear, the carrier, or the sun gear with the fixed output of the fixed-gear-ratio unit in torque communication therebetween. A fourth torque transmitting mechanism interconnects a respective one of the ring gear, the carrier, or the sun gear, and a non-rotating component of the fixed-gear-ratio unit. The fourth torque transmitting mechanism is operable to selectively connect or disconnect the respective one of the ring gear, the carrier, or the sun gear with the non-rotating component of the fixed-gear-ratio unit in torque communication therebetween. A fifth torque transmitting mechanism interconnects a respective one of the ring gear, the carrier, or the sun gear, and the non-rotating component of the fixed-gear-ratio unit. The fifth torque transmitting mechanism is operable to selectively connect or disconnect the respective one of the ring gear, the carrier, or the sun gear with the non-rotating component of the fixed-gear-ratio unit in torque communication therebetween.

Accordingly, the transmission may operate in a fixed-gear ratio mode, in which power from the engine is directed from the transmission input member to the transmission output member through the fixed-gear-ratio unit of the transmission by disengaging the first torque transmitting mechanism, or may be operated in a CVT mode, in which power from the engine is directed from the transmission input member to the transmission output member through the continuously variable unit of the transmission, by engaging the first torque transmitting mechanism. The transmission may be configured to provide an under-drive gear ratio with the fixed-gear-ratio unit of the transmission that may be used to launch the vehicle, and thereafter switch to the continuously variable unit of the transmission for continued operation.

The above features and advantages and other features and advantages of the present teachings are readily apparent from the following detailed description of the best modes for carrying out the teachings when taken in connection with the accompanying drawings.

### BRIEF DESCRIPTION OF THE DRAWINGS

FIG. 1 is a schematic plan view of a powertrain of a vehicle.

FIG. 2 is a schematic plan view of an alternative configuration of the powertrain of the vehicle.

### DETAILED DESCRIPTION

Those having ordinary skill in the art will recognize that terms such as “above,” “below,” “upward,” “downward,” “top,” “bottom,” etc., are used descriptively for the figures, and do not represent limitations on the scope of the disclosure, as defined by the appended claims. Furthermore, the teachings may be described herein in terms of functional and/or logical block components and/or various processing steps. It should be realized that such block components may be comprised of any number of hardware, software, and/or firmware components configured to perform the specified functions.

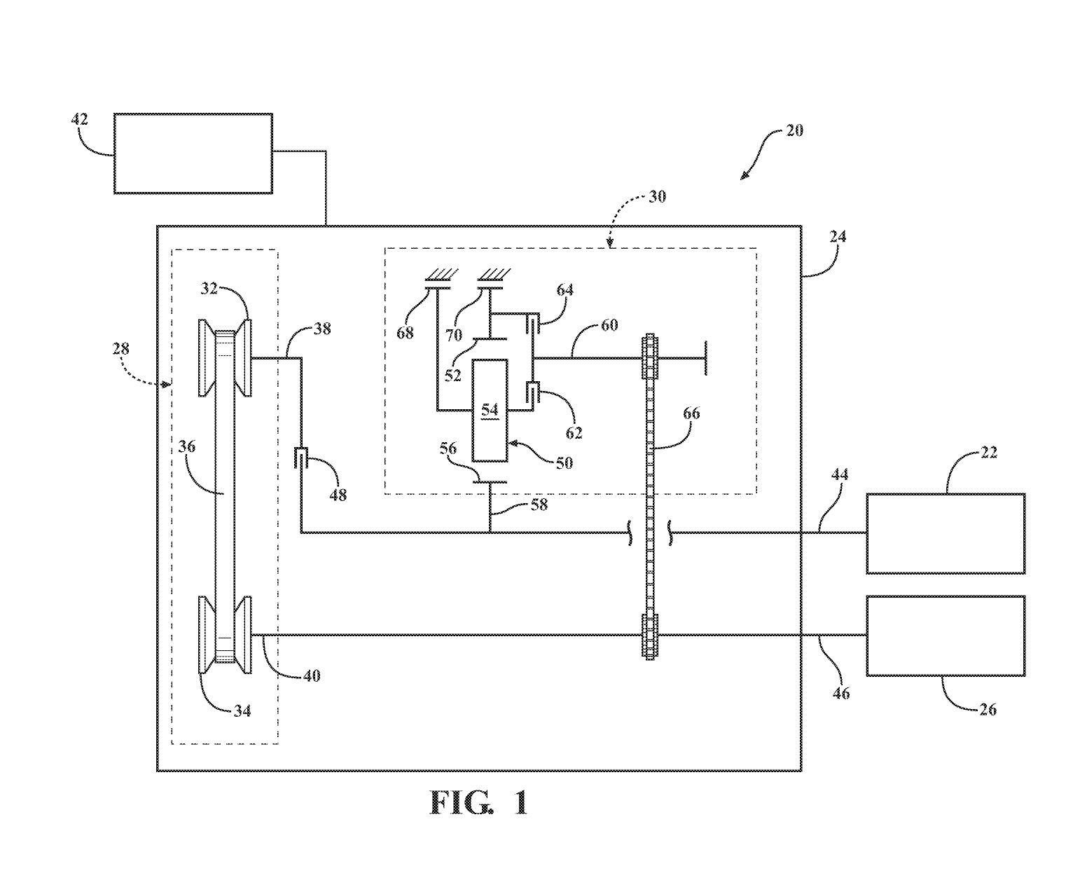

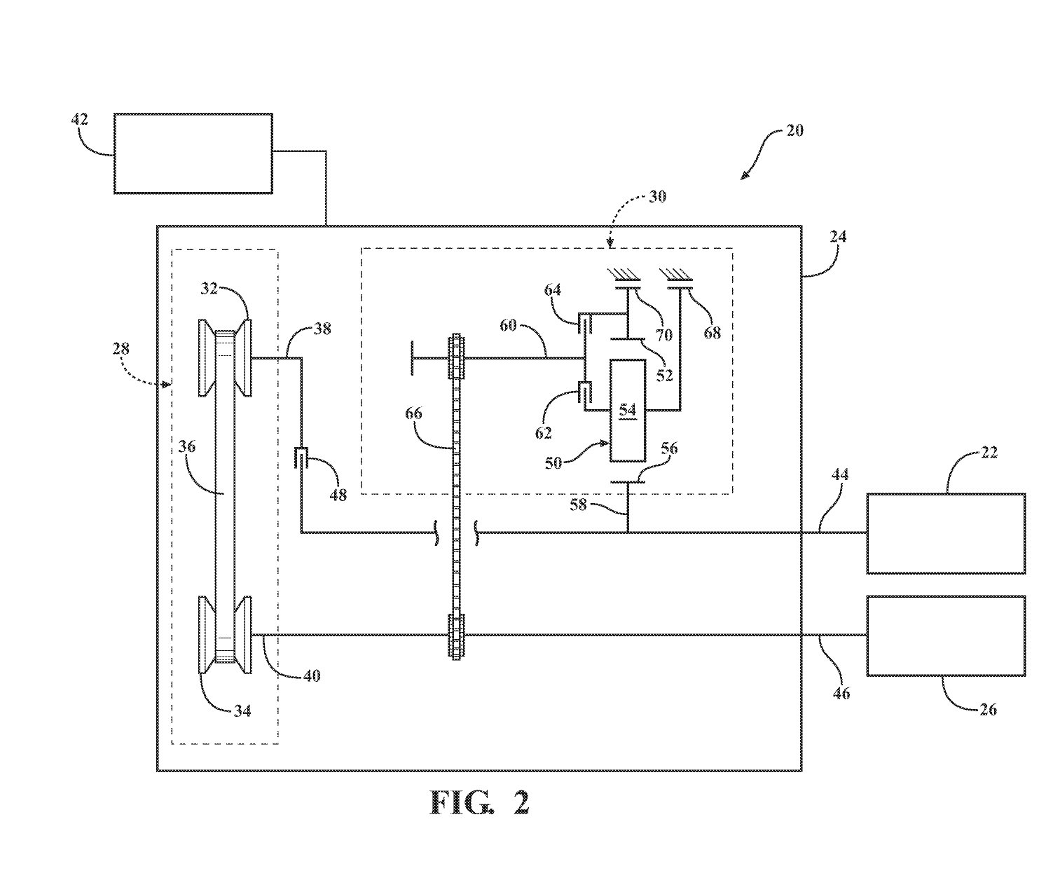

Referring to the Figures, wherein like numerals indicate like parts throughout the several views, a powertrain for a vehicle is generally shown at 20. The powertrain 20 includes an engine 22, a transmission 24, and a final drive 26. The engine 22 may include, for example, a gasoline or diesel engine that is operable to generate torque and provide a rotational output. The transmission 24 is coupled to the engine 22, and is operable to receive torque from the engine 22, and transmit the torque to the final drive 26. The final drive 26 may include, for example, an axle or drive wheel of the vehicle. FIG. 1 and FIG. 2 each include the same components and operate in the same manner. The only difference between the two embodiments shown in FIGS. 1 and 2 is in the relative placement or positioning of the different components described herein. While the exemplary embodiment of the transmission 24 is generally shown in the Figures configured for use in the powertrain 20 for an automobile, it should be appreciated that other embodiments of the transmission 24 may be configured for us in other systems, including but not limited to, boats, tractors, ATV's, generators, pumps, etc.

The transmission 24 includes a continuously variable unit 28, and a fixed-gear-ratio unit 30. The continuously variable unit 28 may alternatively be referred to as a continuously or infinitely variable transmission 24, or as simply a variator. The continuously variable unit 28 is operable to steplessly change through an infinite number of effective gear ratios, between a maximum gear ratio and a minimum gear ratio. As shown in the Figures, the exemplary embodiment of the continuously variable unit 28 includes a belt-driven variator that includes a first adjustable diameter pulley, i.e., a first pulley 32, rotatably coupled to a second adjustable diameter pulley, i.e., a second pulley 34, via an endless rotatable device 36. The first pulley 32 is rotatably coupled to a variator input 38 of the continuously variable unit 28, and the second pulley 34 is rotatably coupled to a variator output 40 of the continuously variable unit 28. Other elements of the continuously variable unit 28 and the operation thereof are known to those skilled in the art, and not described in detail herein. The continuously variable unit 28 may be configured in some other manner, and may include, for example, a toroidal variator, or some other suitable variator configuration. Belt-driven variators and toroidal variators are known to those skilled in the art, and not described in detail herein.

The fixed-gear-ratio unit 30 is operable to change between a pre-defined number of fixed gear ratios. The continuously variable unit 28 is arranged in parallel with the fixed-gear-ratio unit 30. The continuously variable unit 28 and the fixed-gear-ratio unit 30 operate to transfer mechanical power in the form of torque and rotational speed between the engine 22 and the final drive 26. The configuration of the fixed-gear ratio unit is described in greater detail below.

A controller 42 is coupled to the transmission 24, and is operable to control the components of the transmission 24. The controller 42 monitors operation of the transmission 24, and controls various actuators to effect operation of the continuously variable unit 28 and the fixed-gear-ratio unit 30. The controller 42 may control each component of the powertrain 20 described herein. The controller 42 monitors sensor inputs and executes control routines to determine control parameters for the actuators to control operation of the various powertrain 20 components. Driver input devices, such as an accelerator pedal and an associated accelerator pedal position sensor, can be monitored to determine an operator torque request. Various sensors are suitably positioned for sensing and providing signals, including, e.g., an input speed sensor monitoring rotation of a transmission input member 44, variator speed sensor(s) monitoring the variator input 38, and an output speed sensor monitoring rotation of a transmission output member 46. The input speed sensor and output speed sensor may be any suitable rotation position/speed sensing device, such as a Hall-effect sensor.

The controller 42 may include a digital processing capability that issues control signals based on input signals such as vehicle speed and engine 22 torque. The controller 42 may be referred to by similar terms, such as but not limited to, a control module, a module, a control, a control unit, a processor, etc. The controller 42 may include any one or various combinations of Application Specific Integrated Circuit(s) (ASIC), electronic circuit(s), central processing unit(s), e.g., microprocessor(s) and associated memory and storage devices (read only, programmable read only, random access, hard drive, etc.) executing one or more software or firmware programs or routines, combinational logic circuit(s), input/output circuit(s) and devices, signal conditioning and buffer circuitry and other components to provide a described functionality. Software, firmware, programs, instructions, control routines, code, algorithms and similar terms may include any controller 42-executable instruction sets including calibrations and look-up tables. Each controller 42 executes control routine(s) to provide desired functions, including monitoring inputs from sensing devices and other networked controllers and executing control and diagnostic routines to control operation of actuators. Routines may be executed at regular intervals, for example each 100 microseconds. Communications between the controller 42, actuators and/or sensors, and the various components of the powertrain 20 may be accomplished using a direct wired link, a networked communications bus link, a wireless link or any another suitable communications link.

As noted above, the transmission 24 includes the transmission input member 44 and the transmission output member 46. The transmission input member 44 is connected to the engine 22, and is operable to receive the torque from the engine 22. The transmission output member 46 is connected to the final drive 26, and is operable to transmit torque to the final drive 26. As noted above, the continuously variable unit 28 includes the variator input 38, and the variator output 40. The variator output 40 is continuously connected to the transmission output member 46. Accordingly, the variator output 40 always rotates with the transmission output member 46, and cannot be rotatably disconnected from the transmission output member 46.

The variator input 38 is selectively coupled to the transmission input member 44. More specifically, a first torque transmitting mechanism 48 interconnects the variator input 38 and the transmission input member 44. Accordingly, because the first torque transmitting mechanism 48 connects two rotating components, i.e., the transmission input member 44 and the variator input 38, the first torque transmitting mechanism 48 may be referred to as a clutch. The first torque transmitting mechanism 48 is selectively engageable to communicate torque between the variator input 38 and the transmission input member 44. Additionally, the first torque transmitting mechanism 48 is selectively disengageable to disconnect torque communication between the variator input 38 and the transmission input member 44.

As used herein, the term “selectively” is used to describe any controller/controllable operating state, including activated state and/or a deactivated state, or an engaged state and/or a disengaged state, of the different torque transmitting mechanisms described herein. As used here, a torque transmitting mechanism is a device that is capable of selectively transmitting torque between two components. When activated or engaged, the torque transmitting mechanism transmits torque and/or rotation between two components. When deactivated or disengaged, the torque transmitting mechanism does not transmit torque and/or rotation between the respective components. The torque transmitting mechanism may include and/or be referred to as a “clutch” or a “brake”. The term “clutch” is defined herein as a device that uses friction, mechanical interference or some other suitable force transmitting system to couple components, including rotatably coupling coaxial devices, and communicate torque and rotation therebetween. The term “brake” is defined herein as a device that uses friction, mechanical interference or some other suitable force transmitting system to couple components, including one non-rotating component, and communicate torque therebetween. The non-rotating component may include, for example, a housing of the transmission 24.

The fixed-gear-ratio unit 30 includes a planetary gear set 50 having a ring gear 52, a plurality of planet gears supported by a carrier 54, and a sun gear 56. The ring gear 52, the planet gears, and the sun gear 56 are disposed in meshing engagement with each other. Each of the ring gear 52, the carrier 54, and the sun gear 56 define one of a first node, a second node, or a third node of the planetary gear set 50. As described herein with reference to the exemplary embodiment shown in the Figures, the sun gear 56 is defined as the first node, the carrier 54 is defined as the second node, and the ring gear 52 is defined as the third node. However, it should be appreciated that the first node, the second node, and the third node may be defined to include the other components of the planetary gear set 50.

The fixed-gear-ratio unit 30 includes a fixed input 58 and a fixed output 60. The fixed input 58 is continuously connected to the transmission input member 44 and one of the first node, the second node, or the third node of the planetary gear set 50. Accordingly, the fixed input 58 always rotates with the transmission input member 44 and the one of the first node, the second node, or the third node of the planetary gear set 50 that the fixed input 58 is connected to, and cannot be rotatably disconnected from the transmission input member 44, or the one of the first node, the second node, or the third node of the planetary gear set 50 that the fixed input 58 is connected to. As shown in the Figures, the fixed input 58 of the fixed-gear-ratio unit 30 is continuously connected to the sun gear 56 of the planetary gear set 50, i.e., the first node of the planetary gear set 50. However, it should be appreciated that the fixed input 58 may be connected to one of the other components of the planetary gear set 50, e.g., the carrier 54 or the ring gear 52.

The fixed output 60 of the fixed-gear-ratio unit 30 is continuously connected to the transmission output member 46, and is selectively connected to one of the first node, the second node, or the third node of the planetary gear set 50. Accordingly, the fixed output 60 always rotates with the transmission output member 46 and cannot be rotatably disconnected from the transmission output member 46. However, the fixed output 60 is selectively connected to one of the first node, the second node, or the third node of the planetary gear set 50, so that the fixed output 60 may be rotatably connected to or rotatably disconnected from the one of the first node, the second node, or the third node of the planetary gear set 50 that the fixed output 60 is selectively connected to.

A second torque transmitting mechanism 62 interconnects a respective one of the first node, the second node, or the third node of the planetary gear set 50, and the fixed output 60 of the fixed-gear-ratio unit 30. Accordingly, because the second torque transmitting mechanism 62 connects two rotating components, i.e., one of the nodes of the planetary gear set 50 and the fixed output 60, the second torque transmitting mechanism 62 may be referred to as a clutch. The second torque transmitting mechanism 62 is selectively engageable to communicate torque between the respective one of the first node, the second node, or the third node of the planetary gear set 50, and the fixed output 60 of the fixed-gear-ratio unit 30. The second torque transmitting mechanism 62 is selectively disengageable to disconnect torque communication between the respective one of the first node, the second node, or the third node of the planetary gear set 50, and the fixed output 60 of the fixed-gear-ratio unit 30. As shown in the Figures, the second torque transmitting mechanism 62 is directly connected to the carrier 54 of the planetary gear set 50, i.e., the second node of the planetary gear set 50. However, it should be appreciated that the second torque transmitting mechanism 62 may alternatively be connected to one of the other components of the planetary gear set 50, i.e., the sun gear 56 or the ring gear 52.

A third torque transmitting mechanism 64 interconnects one of the first node, the second node, or the third node of the planetary gear set 50, and the fixed output 60 of the fixed-gear-ratio unit 30. Accordingly, because the third torque transmitting mechanism 64 connects two rotating components, i.e., one of the nodes of the planetary gear set 50 and the fixed output 60, the third torque transmitting mechanism 64 may be referred to as a clutch. The third torque transmitting mechanism 64 is selectively engageable to communicate torque between the one of the first node, the second node, or the third node of the planetary gear set 50, and the fixed output 60 of the fixed-gear-ratio unit 30. The third torque transmitting mechanism 64 is selectively disengageable to disconnect torque communication between the one of the first node, the second node, or the third node of the planetary gear set 50, and the fixed output 60 of the fixed-gear-ratio unit 30. As shown in the Figures, the third torque transmitting mechanism 64 is directly connected to the ring gear 52 of the planetary gear set 50, i.e., the third node of the planetary gear set 50. However, it should be appreciated that the third torque transmitting mechanism 64 may alternatively be connected to one of the other components of the planetary gear set 50, i.e., the sun gear 56 or the carrier 54.

Accordingly, as shown in the Figures, the exemplary embodiment of the fixed-gear-ratio unit 30 includes the fixed output 60 selectively connected to both the planet carrier 54 of the planetary gear set 50, i.e., the second node, and the ring gear 52 of the planetary gear set 50, i.e., the third node. More specifically, a second torque transmitting mechanism 62 selectively connects the fixed output 60 and the carrier 54 of the planetary gear set 50, and a third torque transmitting mechanism 64 selectively connects the fixed output 60 and the ring gear 52 of the planetary gear set 50.

As noted above, the fixed output 60 and the transmission output member 46 are continuously connected together for common rotation. The fixed output 60 and the transmission output member 46 may be connected for rotation together in any suitable manner. For example, and as shown in the Figures, an endless rotating member 66 continuously interconnects the transmission output member 46 and the fixed output 60 of the fixed-gear-ratio unit 30. The endless rotating member 66 may include, for example, an endless chain or other similar device. Alternatively, the fixed output 60 and the transmission output member 46 may be connected for rotation in some other manner, such as through a geared engagement therebetween.

A fourth torque transmitting mechanism 68 interconnects a respective one of the first node, the second node, or the third node of the planetary gear set 50, and a non-rotating component of the fixed-gear ratio transmission 24 unit. Accordingly, because the fourth torque transmitting mechanism 68 connects the non-rotating component to a node of the planetary gear set 50, the fourth torque transmitting mechanism 68 may be referred to as a brake. The non-rotating component may include, for example, a housing of the transmission 24. The fourth torque transmitting mechanism 68 is selectively engageable to communicate torque between the respective one of the first node, the second node, or the third node of the planetary gear set 50, and the non-rotating component of the fixed-gear ratio transmission 24 unit. The fourth torque transmitting mechanism 68 is disengageable to disconnect torque communication between the respective one of the first node, the second node, or the third node of the planetary gear set 50, and the non-rotating component of the fixed-gear ratio transmission 24 unit. As shown in the Figures, the fourth torque transmitting mechanism 68 is directly connected to the carrier 54 of the planetary gear set 50, i.e., the second node of the planetary gear set 50. However, it should be appreciated that the fourth torque transmitting mechanism 68 may alternatively be connected to one of the other components of the planetary gear set 50, i.e., the sun gear 56 or the ring gear 52. Additionally, it should be appreciated that both the second torque transmitting mechanism 62 and the fourth torque transmitting mechanism 68 are directly connected to the same node of the planetary gear set 50, i.e., the second node, which as defined herein is the carrier 54 of the planetary gear set 50.

A fifth torque transmitting mechanism 70 interconnects a respective one of the first node, the second node, or the third node of the planetary gear set 50, and the non-rotating component of the fixed-gear ratio transmission 24 unit. Accordingly, because the fifth torque transmitting mechanism 70 connects the non-rotating component to a node of the planetary gear set 50, the fifth torque transmitting mechanism 70 may be referred to as a brake. The fifth torque transmitting mechanism 70 is selectively engageable to communicate torque between the respective one of the first node, the second node, or the third node of the planetary gear set 50, and the non-rotating component of the fixed-gear ratio transmission 24 unit. The fifth torque transmitting mechanism 70 is disengageable to disconnect torque communication between the respective one of the first node, the second node, or the third node of the planetary gear set 50, and the non-rotating component of the fixed-gear ratio transmission 24 unit. As shown in the Figures, the fifth torque transmitting mechanism 70 is directly connected to the ring gear 52 of the planetary gear set 50, i.e., the third node of the planetary gear set 50. However, it should be appreciated that the fifth torque transmitting mechanism 70 may alternatively be connected to one of the other components of the planetary gear set 50, i.e., the sun gear 56 or the carrier 54. Additionally, it should be appreciated that both the third torque transmitting mechanism 64 and the fifth torque transmitting mechanism 70 are directly connected to the same node of the planetary gear set 50, i.e., the third node, which as defined herein is the ring gear 52 of the planetary gear set 50.

When the first torque transmitting mechanism 48 is engaged or activated to transmit torque between the transmission input member 44 and the variator input 38, the transmission 24 operates in a continuously variable mode to transfer torque between the transmission input member 44 and the transmission output member 46 through the continuously variable unit 28. When operating in the continuously variable mode, the second torque transmitting mechanism 62 and the third torque transmitting mechanism 64 are preferably disengaged or deactivated to prevent torque communication between the transmission output member 46 and the planetary gear set 50 through the fixed output 60 of the fixed-gear-ratio unit 30. However, one of the second torque transmitting mechanism 62 or the third torque transmitting mechanism 64 may be engaged or activated when operating in the continuously variable mode, if the fourth torque transmitting mechanism 68 and/or the fifth torque transmitting mechanism 70 are disengaged or deactivated respectively.

When the first torque transmitting mechanism 48 is disengaged or deactivated to not transmit torque between the transmission input member 44 and the variator input 38, the transmission 24 operates in a fixed-gear-ratio mode to transfer torque between the transmission input member 44 and the transmission output member 46 through the fixed-gear-ratio unit 30. When operating in the fixed-gear-ratio mode, the second torque transmitting mechanism 62, the third torque transmitting mechanism 64, the fourth torque transmitting mechanism 68, and the fifth torque transmitting mechanism 70 are either engaged or disengaged as required to achieve the desired fixed gear ratio.

Table 1 below shows the different state, i.e., either engaged or disengaged, for the second torque transmitting mechanism 62, the third torque transmitting mechanism 64, the fourth torque transmitting mechanism 68, and the fifth torque transmitting mechanism 70, when the transmission 24 is operating in the fixed-gear-ratio mode, to achieve the different available gear ratios. It should be appreciated that for all available gear ratios shown in Table 1, when the transmission 24 is operating in the fixed-gear-ratio mode, the first torque transmitting mechanism 48 is deactivated or disengaged to not transmit torque between the transmission input member 44 and the variator input 38. As such, the first torque transmitting mechanism 48 is omitted from Table 1, as it is always disengaged during the fixed-gear-ratio mode. The various modes shown in Table 1 include: a “Reverse” mode, a “Neutral” mode, a first fixed gear ratio “1”, and a second fixed gear ratio “2”. An “X” in the box indicates that the particular torque transmitting mechanism is engaged or activated to transmit torque and effect operation in the associated fixed gear ratio. The second torque transmitting mechanism 62 is shown in the column labeled “C2”, the third torque transmitting mechanism 64 is shown in the column labeled “C3”, the fourth torque transmitting mechanism 68 is shown in the column labeled “B4”, and the fifth torque transmitting mechanism 70 is shown in the column labeled “B5”. The specific gear ratio for each mode is shown in the column labeled “Ratio”.

TABLE 1

| Mode | Ratio | B4 | B5 | C3 | C2 |
|---|---|---|---|---|---|
| Reverse | −2.6 | X | | X | |
| Neutral | 0 | | | | |
| 1 | 3.6 | | X | | X |
| 2 | 1 | | | X | X |

During operation, the transmission 24 may be operated in the fixed-gear-ratio mode to launch the vehicle. The first fixed gear ratio “1” and/or the second fixed-gear-ratio “2” provide highly efficient gear ratios for launching the vehicle. After the vehicle has achieved a desired speed, the transmission 24 may be switched to operate in the continuously variable mode to obtain the efficiency benefits associated with a continuously variable transmission 24. By operating the transmission 24 in this manner, the continuously variable unit 28 may be disengaged from the transmission input member 44 during launch, thereby reducing a required clamping pressure needed to secure a belt between the moveable sheaves, if a belt style continuously variable transmission 24 is used. The reduced clamping pressure reduces losses associated with the belt style continuously variable transmission 24, which increases fuel efficiency.

The detailed description and the drawings or figures are supportive and descriptive of the disclosure, but the scope of the disclosure is defined solely by the claims. While some of the best modes and other embodiments for carrying out the claimed teachings have been described in detail, various alternative designs and embodiments exist for practicing the disclosure defined in the appended claims.

1. A transmission comprising:
a transmission input member;
a transmission output member;
a continuously variable unit having a variator input selectively coupled to the transmission input member, and a variator output continuously connected to the transmission output member;
a fixed-gear-ratio unit including a planetary gear set having a ring gear, a plurality of planet gears supported by a carrier, and a sun gear, wherein the ring gear, the planet gears, and the sun gear are disposed in meshing engagement with each other, and wherein each of the ring gear, the carrier, and the sun gear defines one of a first node, a second node, or a third node of the planetary gear set;
wherein the fixed-gear-ratio unit includes a fixed input continuously connected to the transmission input member and one of the first node, the second node, or the third node of the planetary gear set; and
wherein the fixed-gear-ratio unit includes a fixed output continuously connected to the transmission output member, and selectively connected to one of the first node, the second node, or the third node of the planetary gear set.

2. The transmission set forth in claim 1 further comprising a first torque transmitting mechanism interconnecting the variator input and the transmission input member, wherein the first torque transmitting mechanism is selectively engageable to communicate torque between the variator input and the transmission input member, and disengageable to disconnect torque communication between the variator input and the transmission input member.

3. The transmission set forth in claim 2 further comprising a second torque transmitting mechanism interconnecting one of the first node, the second node, or the third node of the planetary gear set, and the fixed output of the fixed-gear-ratio unit, wherein the second torque transmitting mechanism is selectively engageable to communicate torque between the one of the first node, the second node, or the third node of the planetary gear set, and the fixed output of the fixed-gear-ratio unit, and disengageable to disconnect torque communication between the one of the first node, the second node, or the third node of the planetary gear set, and the fixed output of the fixed-gear-ratio unit.

4. The transmission set forth in claim 3 further comprising a third torque transmitting mechanism interconnecting one of the first node, the second node, or the third node of the planetary gear set, and the fixed output of the fixed-gear-ratio unit, wherein the third torque transmitting mechanism is selectively engageable to communicate torque between the one of the first node, the second node, or the third node of the planetary gear set, and the fixed output of the fixed-gear-ratio unit, and disengageable to disconnect torque communication between the one of the first node, the second node, or the third node of the planetary gear set, and the fixed output of the fixed-gear-ratio unit.

5. The transmission set forth in claim 4 further comprising a fourth torque transmitting mechanism interconnecting one of the first node, the second node, or the third node of the planetary gear set, and a non-rotating component of the fixed-gear ratio transmission unit, wherein the fourth torque transmitting mechanism is selectively engageable to communicate torque between the one of the first node, the second node, or the third node of the planetary gear set, and the non-rotating component of the fixed-gear ratio transmission unit, and disengageable to disconnect torque communication between the one of the first node, the second node, or the third node of the planetary gear set, and the non-rotating component of the fixed-gear ratio transmission unit.

6. The transmission set forth in claim 5 further comprising a fifth torque transmitting mechanism interconnecting one of the first node, the second node, or the third node of the planetary gear set, and the non-rotating component of the fixed-gear ratio transmission unit, wherein the fifth torque transmitting mechanism is selectively engageable to communicate torque between the one of the first node, the second node, or the third node of the planetary gear set, and the non-rotating component of the fixed-gear ratio transmission unit, and disengageable to disconnect torque communication between the one of the first node, the second node, or the third node of the planetary gear set, and the non-rotating component of the fixed-gear ratio transmission unit.

7. The transmission set forth in claim 6 wherein the second torque transmitting mechanism and the fourth torque transmitting mechanism are directly connected to the same node of the planetary gear set.

8. The transmission set forth in claim 7 wherein the second torque transmitting mechanism and the fourth torque transmitting mechanism are directly connected to the carrier of the planetary gear set.

9. The transmission set forth in claim 7 wherein the third torque transmitting mechanism and the fifth torque transmitting mechanism are directly connected to the same node of the planetary gear set.

10. The transmission set forth in claim 9 wherein the third torque transmitting mechanism and the fifth torque transmitting mechanism are directly connected to the ring gear of the planetary gear set.

11. The transmission set forth in claim 9 wherein the fixed input of the fixed-gear-ratio unit is continuously connected to the sun gear of the planetary gear set.

12. The transmission set forth in claim 11 wherein the fixed output of the fixed-gear-ratio unit is selectively connected to the ring gear of the planetary gear set through the third torque communicating mechanism, and is selectively connected to the carrier of the planetary gear set through the second torque communicating mechanism.

13. The transmission set forth in claim 1 further comprising an endless rotating member continuously interconnecting the transmission output member and the fixed output of the fixed-gear-ratio unit.

14. A powertrain comprising:
an engine;
a transmission coupled to the engine and operable to receive torque from the engine, the transmission including:
a transmission input member connected to the engine, and operable to receive the torque from the engine;
a transmission output member;
a continuously variable transmission (CVT) unit having a variator input, and a variator output continuously connected to the transmission output member;
a first torque transmitting mechanism interconnecting the variator input and the transmission input member, and operable to selectively connect or disconnect the variator input and the transmission input member in torque communication therebetween;
a fixed-gear-ratio unit including a planetary gear set having a ring gear, a plurality of planet gears supported by a carrier, and a sun gear, wherein the ring gear, the planet gears, and the sun gear are disposed in meshing engagement with each other;
wherein the fixed-gear-ratio unit includes a fixed input continuously connected to the transmission input member and one of the ring gear, the carrier, or the sun gear;
wherein the fixed-gear-ratio unit includes a fixed output continuously connected to the transmission output member, and selectively connected to a respective one of the ring gear, the carrier, or the sun gear;
a second torque transmitting mechanism interconnecting a respective one of the ring gear, the carrier, or the sun gear, and the fixed output of the fixed-gear-ratio unit, and operable to selectively connect or disconnect the respective one of the ring gear, the carrier, or the sun gear with the fixed output of the fixed-gear-ratio unit in torque communication therebetween;
a third torque transmitting mechanism interconnecting a respective one of the ring gear, the carrier, or the sun gear, and the fixed output of the fixed-gear-ratio unit, and operable to selectively connect or disconnect the respective one of the ring gear, the carrier, or the sun gear with the fixed output of the fixed-gear-ratio unit in torque communication therebetween;
a fourth torque transmitting mechanism interconnecting a respective one of the ring gear, the carrier, or the sun gear, and a non-rotating component of the fixed-gear-ratio unit, and operable to selectively connect or disconnect the respective one of the ring gear, the carrier, or the sun gear with the non-rotating component of the fixed-gear-ratio unit in torque communication therebetween; and
a fifth torque transmitting mechanism interconnecting a respective one of the ring gear, the carrier, or the sun gear, and the non-rotating component of the fixed-gear-ratio unit, and operable to selectively connect or disconnect the respective one of the ring gear, the carrier, or the sun gear with the non-rotating component of the fixed-gear-ratio unit in torque communication therebetween.

15. The powertrain set forth in claim 14 wherein the second torque transmitting mechanism and the fourth torque transmitting mechanism are directly connected to the same one of the ring gear, the carrier, or the sun gear.

16. The powertrain set forth in claim 15 wherein the third torque transmitting mechanism and the fifth torque transmitting mechanism are directly connected to the same one of the ring gear, the carrier, or the sun gear.

17. The powertrain set forth in claim 14 wherein the second torque transmitting mechanism and the fourth torque transmitting mechanism are directly connected to the carrier of the planetary gear set.

18. The powertrain set forth in claim 17 wherein the third torque transmitting mechanism and the fifth torque transmitting mechanism are directly connected to the ring gear of the planetary gear set.

19. The powertrain set forth in claim 18 wherein the fixed input of the fixed-gear-ratio unit is continuously connected to the sun gear of the planetary gear set.

20. The powertrain set forth in claim 14 further comprising an endless rotating member continuously interconnecting the transmission output member and the fixed output of the fixed-gear-ratio unit.
